(19) United States
(12) Patent Application Publication
(10) Pub. No.: US 2013/0041090 A1
(43) Pub. Date: Feb. 14, 2013

(54) METHOD FOR PRODUCING THERMOPLASTIC ELASTOMER COMPOSITION

(71) Applicants: Shuhei ONO, Ichihara-shi (JP); Nobuhiro NATSUYAMA, Ichihara-shi (JP)

(72) Inventors: Shuhei ONO, Ichihara-shi (JP); Nobuhiro NATSUYAMA, Ichihara-shi (JP)

(73) Assignee: Sumitomo Chemical Company, Limited, Tokyo (JP)

(21) Appl. No.: 13/490,657

(22) Filed: Jun. 7, 2012

(30) Foreign Application Priority Data
Jun. 14, 2011 (JP) 2011-131917

(51) Int. Cl. C08L 19/00; C08K 5/01

(52) U.S. Cl. 524/509; 525/132

(57) ABSTRACT

There is disclosed a method for producing a thermoplastic elastomer composition, the method involving subjecting an ethylene-α-olefin-based copolymer rubber (A) and a polyolefin-based resin (B) in the presence of an alkylphenol resin (C) and a metal halide (D) to dynamic thermal treatment within a melt-kneading apparatus, wherein the metal halide (D) is a powder, and a mixture of a powder of the metal halide (D) and a particle having a volume-average particle diameter of 0.1 μm to 3 mm is continuously fed to the melt-kneading apparatus.

### BACKGROUND OF THE INVENTION

1. Technical Field

The present invention relates to a method for producing a thermoplastic elastomer composition.

2. Background Art

Olefin-based thermoplastic elastomer compositions have the same molding processability as olefin-based thermoplastic resins and therefore are being used in a broad range of applications, for instance in automotive parts, household electric appliance parts, medical device parts, electric wires, and so on. This olefin-based thermoplastic elastomer composition is obtained by subjecting an olefin-based rubber and a polyolefin-based resin to dynamic thermal treatment in the presence of a crosslinking agent.

As the crosslinking agent, organic peroxides, sulfur, alkylphenol resins, and so on have been used. In some cases a crosslinking aid is used with the crosslinking agent; as the crosslinking aid, compounds having two or more polymerizable double bonds, such as N,N-m-phenylenebismaleimide and trimethylolpropane trimethacrylate, metal halides, such as stannous chloride and ferric chloride, metal oxides, such as zinc oxide and magnesium oxide, and so on have been used.

As a method for producing of such an olefin-based thermoplastic elastomer composition, for example, JP 2-235949 A has disclosed a method in which a component composed of a polypropylene-based resin, an ethylene-propylene-ethylidene norbornene copolymer rubber, a paraffinic oil, and stannous chloride and an alkylphenol resin are fed into a Banbury mixer, and then the polypropylene-based resin, the ethylene-propylene-ethylidene norbornene copolymer rubber, and the paraffinic oil are subjected to dynamic thermal treatment in the presence of the alkylphenol resin, which is a crosslinking agent, and the stannous chloride, which is a crosslinking accelerator, in the Banbury mixer.

However, use of a metal halide like stannous chloride as a crosslinking aid and continuous feed of the metal halide to a melt-kneading apparatus such as an extruder may lead to classification of the metal halide due to its poor storage stability, which may result in great fluctuations in the feed rate of the metal halide due to the deterioration in the feed stability of the metal halide and therefore the conventional method for producing a thermoplastic elastomer composition has not been satisfactory enough.

Under such a situation, the problem to be solved by the present invention is to provide a method for producing a thermoplastic elastomer composition, the method using a metal halide as a crosslinking aid, wherein the method will afford improved feed stability of the metal halide to a melt-kneading apparatus through improvement in the storage stability of the metal halide.

### SUMMARY OF THE INVENTION

The present invention relates to a method for producing a thermoplastic elastomer composition, the method comprising subjecting the following component (A) and component (B) in the presence of the following component (C) and component (D) to dynamic thermal treatment within a melt-kneading apparatus, wherein the component (D) is a powder, and a mixture of a powder of the component (D) and a particle having a volume-average particle diameter of 0.1 μm to 3 mm is fed to the melt-kneading apparatus,

component (A): ethylene-α-olefin-based copolymer rubber
component (B): polyolefin-based resin
component (C): alkylphenol resin
component (D): metal halide.

In a method for producing a thermoplastic elastomer composition wherein the method uses a metal halide as a crosslinking aid, the storage stability of the metal halide is improved and thereby the feed stability of the metal halide to a melt-kneading apparatus is improved by the present invention.

### DETAILED DESCRIPTION OF THE PREFERRED EMBODIMENTS

The component (A) is an ethylene-α-olefin-based copolymer rubber. The ethylene-α-olefin-based copolymer rubber is a copolymer with an A hardness defined in JIS K-6253 (1997) of 85 or less, the copolymer having monomer units based on ethylene (namely, ethylene units) and monomer units based on an α-olefin having 3 to 10 carbon atoms (namely, α-olefin units having 3 to 10 carbon atoms). Examples of the α-olefin having 3 to 10 carbon atoms include propylene, 1-butene, 2-methylpropylene, 1-pentene, 3-methyl-1-butene, 1-hexene, 4-methyl-1-pentene, and 1-octene; the ethylene-α-olefin-based copolymer rubber of component (A) may contain one or more kinds of α-olefin. Propylene and 1-butene are preferred as the α-olefin having 3 to 10 carbon atoms, and propylene is more preferred.

The ethylene-α-olefin-based copolymer rubber may have one or more kinds of monomer units based on another monomer in addition to the ethylene units and the α-olefin units having 3 to 10 carbon atoms. Examples of such another monomer include conjugated dienes having 4 to 8 carbon atoms such as 1,3-butadiene, 2-methyl-1,3-butadiene (namely, isoprene), 1,3-pentadiene, and 2,3-dimethyl-1,3-butadiene; nonconjugated dienes having 5 to 15 carbon atoms such as dicyclopentadiene, 5-ethylidene-2-norbornene, 1,4-hexadiene, 1,5-dicyclooctadiene, 7-methyl-1,6-octadiene, and 5-vinyl-2-norbornene; vinyl ester compounds such as vinyl acetate; unsaturated carboxylic acid esters, such as methyl acrylate, ethyl acrylate, butyl acrylate, methyl methacrylate, and ethyl methacrylate; and unsaturated carboxylic acids, such as acrylic acid and methacrylic acid. 5-Ethylidene-2-norbornene and dicyclopentadiene are preferred.

The content of the ethylene units of the ethylene-α-olefin-based copolymer rubber is usually 30 to 85% by weight, preferably 40 to 80% by weight; the content of the α-olefin units having 3 to 10 carbon atoms is usually 5 to 70% by weight, preferably 15 to 60% by weight; and the content of other monomer units other than the ethylene units and the α-olefin units is usually 0 to 30% by weight, preferably 0 to 20% by weight. The overall amount of the monomer units in the ethylene-α-olefin-based copolymer rubber is considered to be 100% by weight.

Examples of the ethylene-α-olefin-based copolymer rubber include ethylene-propylene copolymer rubbers, ethylene-1-butene copolymer rubbers, ethylene-1-hexene copolymer rubbers, ethylene-1-octene copolymer rubbers, ethylene-propylene-1-butene copolymer rubbers, ethylene-propylene-1-hexene copolymer rubbers, ethylene-propylene-1-octene copolymer rubbers, ethylene-propylene-5-ethylidene-2-norbornene copolymer rubbers, ethylene-propylene-dicyclopentadiene copolymer rubbers, ethylene-propylene-1,4-hexadiene copolymer rubbers, and ethylene-propylene-5-vinyl-2-norbornene copolymer rubbers. As component (A), one or more kinds of ethylene-α-olefin-based copolymer rubber may be used. Ethylene-propylene copolymers whose content of ethylene units is 40 to 80 parts by weight and content of propylene units is 20 to 60 parts by weight (where the sum total of the content of ethylene units and the content of propylene units is 100 parts by weight) or ethylene-propylene-5-ethylidene-2-norbornene copolymers whose content of ethylene units is 40 to 80 parts by weight, content of propylene units is 20 to 60 parts by weight, and content of 5-ethylidene-2-norbornene units is 0.1 to 20 parts by weight (where the sum total of the content of ethylene units, the content of propylene units, and the content of 5-ethylidene-2-norbornene units is 100 parts by weight) are preferred.

In order to enhance the mechanical strength of a thermoplastic elastomer composition molded article, the Mooney viscosity (ML₁₊₄100° C.) of the ethylene-α-olefin-based copolymer rubber is preferably 10 or more, more preferably 30 or more. In order to improve the appearance of the molded article, it is preferably 350 or less, more preferably 300 or less. The Mooney viscosity (ML₁₊₄100° C.) is measured in accordance with JIS K6300. The Mooney viscosity of the ethylene-α-olefin-based copolymer rubber can be adjusted by controlling, for example, the polymerization temperature, the added amount of hydrogen, the polymerization time, and the ratio of the amounts of the components to constitute a catalyst.

In order to enhance the mechanical strength of a thermoplastic elastomer composition molded article, the intrinsic viscosity of the ethylene-α-olefin-based copolymer rubber measured in 135° C. tetralin is preferably 0.5 dl/g or more, more preferably 1 dl/g or more. In order to improve the appearance of the molded article, it is preferably 8 dl/g or less, more preferably 6 dl/g or less. The intrinsic viscosity of the ethylene-α-olefin-based copolymer rubber can be adjusted by controlling, for example, the polymerization temperature, the added amount of hydrogen, the polymerization time, and the ratio of the amounts of the components to constitute a catalyst.

The ethylene-α-olefin-based copolymer rubber can be produced by conventional methods. Component (B) is a polyolefin-based resin.

Polyolefin-based resins are polymers containing 50% by weight of more of repeating units derived from one sort or two or more sorts of olefin having 2 to 10 carbon atoms, such as ethylene, propylene, 1-butene, and 1-hexene and having an A hardness of JIS K-6253 (1997) being higher than 98. Such polyolefin-based resins include homopolymers or copolymers of ethylene, propylene, 1-butene, 1-pentene, 1-hexene, 4-methyl-1-pentene, 1-octene, and 1-decene. Polypropylene-based resins are preferred.

Polypropylene-based resins are crystalline polymers having the content of monomer units based on propylene (i.e., propylene units) in a polymer is 50 to 100% by weight where the overall amount of the monomer units in the polymer is considered to be 100% by weight. Preferably, they are polymers containing having a content of the propylene units in a polymer is 80 to 100% by weight. Crystalline polymers are polymers with which a crystal melting peak is observed within a temperature range of from −50° C. to 200° C. in differential scanning calorimetry (DSC) measurement in accordance with JIS K7122 (1987) and the heat of crystal fusion of the peak exceeds 30 J/g.

Examples of such polypropylene-based resins include propylene homopolymers, and copolymers of propylene with at least one comonomer selected from the comonomer group consisting of ethylene and α-olefins having 4 to 10 carbon atoms (e.g., 1-butene, 1-hexene, 1-pentene, 1-octene, and 4-methyl-1-pentene). Such copolymers may be either random copolymers or block copolymers. Examples of such copolymers include propylene-ethylene copolymers, propylene-1-butene copolymers, propylene-1-hexene copolymers, propylene-1-octene copolymers, propylene-ethylene-1-butene copolymers, and ethylene-propylene-1-hexene copolymers. What are preferred as a polypropylene-based resin are propylene homopolymers, propylene-ethylene copolymers, and propylene-1-butene copolymers.

Examples of the structural configuration of polypropylene-based resins include isotactic structure, syndiotactic structure, and structure in which the preceding structures are mixed. It is preferred that the main structure is an isotactic structure.

Polypropylene-based resins can be produced by conventional polymerization methods using a Ziegler Natta catalyst, a metallocene catalyst, or the like. Examples of such polymerization methods include solution polymerization, bulk polymerization, slurry polymerization, and vapor phase polymerization.

The melt flow rate (measured under a load of 21.18 N at a temperature of 230° C. in accordance with JIS K7210), of a polypropylene-based resin is preferably 0.1 to 300 g/10 min, more preferably 0.5 to 200 g/10 min. The melt flow rate of polypropylene-based resins can be adjusted by controlling the polymerization temperature, the amount of hydrogen to be added, the polymerization time, and the ratio of the amounts of components constituting a catalyst.

Component (C) is an alkylphenol resin. Examples of the alkylphenol resin include compounds represented by the following formula generally used as a crosslinking agent for rubber (see U.S. Pat. Nos. 3,287,440 and 3,709,840):

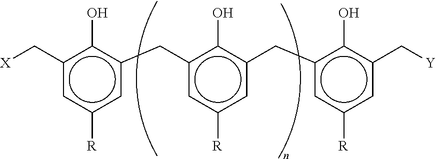

wherein n represents an integer of 0 to 10, X and Y each independently represent a hydroxyl group, a halogenated alkyl group, or a halogen atom, and R represents a saturated hydrocarbon group having 1 to 15 carbon atoms.

Examples of the alkylphenol resin include alkylphenol formaldehyde and brominated alkylphenol formaldehyde. Alkylphenol resins having a methylol group are preferred.

Compound represented by the formula given above can be produced by making a substituted phenol and an aldehyde undergo condensation polymerization using an alkaline catalyst.

The alkylphenol resin is preferably used in combination with a dispersing agent like metal oxides and stearic acid.

Component (D) is a metal halide. Examples of the metal halide include stannous chloride anhydride, stannous chloride dihydrate, and ferric chloride. From the reactivity point of view, stannous chloride dihydrate is preferred. The shape of component (D) is usually a powder.

In the present production method, the following component (E) and/or an additive in addition to component (A) and component (B) may be subjected to dynamic thermal treatment in the presence of component (C) and component (D). The “dynamic thermal treatment” referred to in the present invention means treatment involving melt-kneading under shearing force.

Component (E): mineral oil.

Component (E) is a mineral oil, examples of which include aromatic mineral oils, naphthenic mineral oils, and paraffinic mineral oils. Paraffinic mineral oils are preferred. Mineral oils with a kinetic viscosity at 40° C. of 10 to 1,000 mm²/s are preferred, and mineral oils with a kinetic viscosity at 40° C. of 15 to 800 mm²/s are more preferred. Kinetic viscosity is measured in accordance with JIS K2283-3.

In the present production method, the ethylene-α-olefin-based copolymer rubber of component (A) may be used in the form of an oil-extended ethylene-α-olefin-based copolymer rubber containing a mineral oil. Examples of the method of blending a mineral oil to an ethylene-α-olefin-based copolymer rubber include (1) a method in which both the materials are kneaded mechanically by using a kneading machine such as a roll and a Banbury mixer, and (2) a method in which the mineral oil is added to a solution of the ethylene-α-olefin-based copolymer rubber and then the solvent is removed by steam stripping or the like.

Examples of the above-mentioned additive include antioxidants, heat stabilizers, light stabilizers, UV absorbers, release agents, tackifiers, colorants, neutralizers, lubricants, dispersing agents, flame retardants, antistatic agents, conductivity imparting agents, antibacterial agents, germicides, carbon black, talc, clay, silica, inorganic fillers, such as glass fiber, and carbon fibers.

As the melt-kneading apparatus for performing dynamic thermal treatment, conventional machines, such as mixing rolls, which are of opened type, and Banbury mixers, kneaders, single screw extruders and twin screw extruders, which are of closed type, can be used. Alternatively, it is also permitted to combine two or more types of apparatuses. A twin screw extruder is preferred.

In the present production method, component (D) is fed in the form of a mixture with a particle having a volume-average particle diameter of 0.1 μm to 3 mm to a melt-kneading apparatus.

As the particle, particles of fillers such as carbon black, silica, titanium dioxide, zinc oxide, talc, clay, calcium carbonate, diatomaceous earth, alumina, graphite, and glass; powders of olefin-based resins such as polyethylene and polypropylene; and so on are used. An olefin-based resin powder is preferred. Although means for mixing such particle with a powder of component (D) include a Nauter mixer, a kneader, a batch type blender, a tumbler mixer, a Banbury mixer, a Henschel mixer, a mechanochemical apparatus, and a melt-kneading apparatus, mixing apparatuses such as a tumbler mixer and a Henschel mixer, which are of non-melt type, are preferred.

The volume-average particle diameters of the particle is 0.1 μm to 3 mm, preferably 0.5 μm to 2 mm, and more preferably 1.0 μm to 1.5 mm.

The particle with a volume-average particle diameters of 0.1 μm to 3 mm preferably has a bulk density of 0.15 to 5.0 g/cm³, more preferably 0.20 to 4.0 g/cm³. The bulk density is measured in accordance with JIS K6720 (1999).

The volume-average particle diameter is determined by feeding the particle into ethanol, dispersing the particle in ethanol by ultrasonic treatment, and then measuring the resulting dispersion liquid by a laser diffraction/scattering type particle size distribution analyzer. As the ultrasonic generator to be used for ultrasonic treatment, one with an oscillation frequency of 20 to 60 kHz and an output of 50 to 400 W is used. Examples of the method of applying ultrasonic waves include a method in which a ultrasonic wave generation terminal is immersed in ethanol in which a particle has been fed and then ultrasonic waves are applied, and a method in which water is poured into a ultrasonic generator called an ultrasonic bath or the like, and then a container containing ethanol in which a particle has been fed is immersed into this water. Although the temperature of liquid ethanol is increased by the application of ultrasonic waves, the temperature of ethanol at the onset of the ultrasonic wave application is desirably about 10° C. to about 30° C.

In the mixture of a particle with a volume-average particle diameter of 0.1 μm to 3 mm and a powder of component (D), the content of component (D) is preferably 0.1 to 50% by weight, more preferably 0.5 to 40% by weight, and even more preferably 1 to 30% by weight.

The amount of component (D) to be fed to the melt-kneading apparatus is preferably 0.1 to 20 parts by weight, more preferably 0.2 to 15 parts by weight per 100 parts by weight of components (A), (B), and (E) in total. Although the method of feeding component (D) to the melt-kneading apparatus is not particularly restricted, a continuous, weight-basis feeding method is preferred.

The amount of component (C) to be made present during the dynamic thermal treatment is preferably 0.5 to 5 parts by weight, more preferably 1 to 5 parts by weight per 100 parts by weight of components (A), (B), and (E) in total.

In order to enhance the softness of the thermoplastic elastomer composition, the amount of component (A) to be subjected to dynamic thermal treatment is preferably 10 parts by weight or more, more preferably 15 parts by weight or more where the total amount of components (A), (B), and (E) is considered to be 100 parts by weight. In order to increase the flowability of the thermoplastic elastomer composition and improve the appearance of molded articles made of the thermoplastic elastomer composition, it is preferably 60 parts by weight or less, more preferably 55 parts by weight or less.

In order to increase the flowability of the thermoplastic elastomer and improve the appearance of molded articles of the thermoplastic elastomer composition, the amount of component (B) to be subjected to dynamic thermal treatment is preferably 5 parts by weight or more, more preferably 10 parts by weight or more where the total amount of components (A), (B) and (E) is considered to be 100 parts by weight. In order to improve the flexibility of the thermoplastic elastomer composition, it is preferably 50 parts by weight or less, and more preferably 45 parts by weight or less.

The amount of the component (E) to be subjected to the dynamic thermal treatment is preferably 5 parts by weight or more for enhancing the flowability of the thermoplastic elastomer and improving the appearance of molded articles of the thermoplastic elastomer composition where the overall amount of the component (A), component (B), and component (E) is considered to be 100 parts by weight. In order to improve the appearance of molded articles of the thermoplastic elastomer composition, it is preferably 70 parts by weight or less, and more preferably 65 parts by weight or less.

The temperature of the dynamic thermal treatment is usually 150 to 300° C., and preferably 170 to 280° C., and the time of the dynamic thermal treatment is usually 0.1 to 30 minutes, and preferably 0.2 to 20 minutes.

The thermoplastic elastomer composition obtained by the present invention is shaped using commonly employed molding methods, such as injection molding, extrusion forming, hollow molding, and compression molding. The thermoplastic elastomer composition is used as a material in a broad range of fields, for applications such as automotive parts (e.g., weather strips, ceiling materials, interior sheets, bumper moldings, side moldings, air spoilers, air duct hoses, cup holders, side brake grips, shift knobs covers, seat adjustment latches; flapper door seals, wire harness grommets, rack and pinion boots, suspension cover boots, glass guides, inner beltline seals, roof guides, trunk lid seals, molded quarter window gaskets, corner moldings, glass encapsulation, hood seals, glass run channels, secondary seals, various packings), building parts (e.g., water stops, joint sealers, building window frames), sports instruments (e.g., golf club grips, tennis racket grips), industrial parts (e.g., hose tubes, gaskets), household electric appliance parts (e.g., hoses, packings), medical device parts, electric wires, and miscellaneous goods.

### EXAMPLES

The present invention is described in more detail below by Examples.

The raw materials and the evaluation methods used in the following Examples are as follows.

### [Raw Materials Used]

Components (A), (E): Oil extended rubber prepared by adding 100 parts by weight of paraffinic mineral oil to 100 parts by weight of ethylene-propylene-5-ethylidene-2-norbornene copolymer rubber (Mooney viscosity (ML₁₊₄100° C.)=63, content of ethylene units=66% by weight, content of 5-ethylidene-2-norbornene units=4% by weight)
Component (B): Polypropylene resin (propylene homopolymer, produced by Sumitomo Chemical Co., Ltd., commercial name: NOBLEN D101, MFR (230° C., 21.18 N)=0.7 g/10 min)
Component (C): Alkylphenol-formaldehyde condensate (produced by Taoka Chemical Co., Ltd., commercial name: Tackirol 201)
Component (D): Stannous chloride dihydrate (produced by Nihon Kagaku Sangyo Co., Ltd.)
Component (E): Paraffinic mineral oil (produced by Idemitsu Kosan Co., Ltd., commercial name: Diana Process Oil)
Antioxidant: Phenolic antioxidant (produced by Ciba Japan K.K., commercial name: IRGANOX 1010)
Particle: Talc (produced by NIPPON TALC Co., Ltd., commercial name: JR37, volume average particle diameter: 5.4 μm, bulk density: 0.17 g/cm³)

Polypropylene powder (volume average particle diameter: 750 μm, bulk density: 0.48 g/cm³)

Polyethylene powder (produced by Sumitomo Seika Chemicals Co., Ltd., FLO-THENE UF-4, volume average particle diameter: 20 μm, bulk density: 0.25 g/cm³)

titanium dioxide (produced by Ishiraha Sangyo Kaisha, Ltd., TIPAQUE R-550, volume average particle diameter: 0.75 μm, bulk density: 0.61 g/cm³)

Pellet: Polypropylene pellet (volume average particle diameter: 4 mm, bulk density: 0.55 g/cm³)

### [Method of Evaluation]

### 1. Method of Evaluation of Storage Stability

A mixture in which a stannous chloride powder has been diluted with a particulate material was put into a colorless, transparent bottle, then stored for 12 hours in a thermohygrostat chamber with a temperature of 25° C. and a humidity of 50%, and then visually judged. Where stannous chloride had been well dispersed in the granular solid, a judgment “storage stability is excellent” was made, where stannous chloride had been well dispersed but partially have aggregated, a judgment “storage stability is good” was made, and where stannous chloride had been classified, judgment “storage stability is poor” is made.

### 2. Method of Evaluation of Feed Stability of Stannous Chloride Dihydrate

A stannous chloride dihydrate powder or a mixture of a prescribed particle and a stannous chloride dihydrate powder was fed to a twin screw extruder continuously and the change of the fed amount with time (namely, the change of the feeding rate) was measured. Where the fed amount at every time is within the range of ±15% by weight of the target feeding rate, a judgment “feed stability is excellent” was made, where the fed amount at every time is occasionally beyond the range of 15% by weight of the target feeding rate but it is always within the range of 25% by weight of the target feeding rate, a judgment “feed stability is good” was made, and where it is occasionally beyond the range of ±25% by weight of the target feeding rate, a judgment “feed stability is poor” was made.

### [Properties of Mixture of Stannous Chloride Dihydrate Powder And Particles, Etc.]

### Test Example 1

In a hermetically sealable glass container were mixed 70 parts by weight of talc particle and 30 parts by weight of stannous chloride dihydrate powder. The storage stability of the resulting mixture was excellent.

### Test Example 2

In a hermetically sealable glass container were mixed 70 parts by weight of polypropylene powder and 30 parts by weight of stannous chloride dihydrate powder. The storage stability of the resulting mixture was excellent.

### Test Example 3

In a hermetically sealable glass container were mixed 70 parts by weight of polypropylene pellet and 30 parts by weight of stannous chloride dihydrate powder. The storage stability of the resulting mixture was poor.

### Test Example 4

In a hermetically sealable glass container were mixed 70 parts by weight of polyethylene powder and 30 parts by weight of stannous chloride dihydrate powder. The storage stability of the resulting mixture was excellent.

### Test Example 5

In a hermetically sealable glass container were mixed 70 parts by weight of titanium dioxide powder and 30 parts by weight of stannous chloride dihydrate powder. The storage stability of the resulting mixture was excellent.

### Preparation of Thermoplastic Elastomer Composition

### Example 1

To a twin screw extruder were fed continuously 62 parts by weight of oil extended rubber, 24 parts by weight of polypropylene resin pellets which were ground, 14 parts by weight of paraffin series mineral oils, 0.1 parts by weight of phenolic antioxidant powders, 1.5 parts by weight of alkylphenol formaldehyde condensation product powders, and 2.4 parts by weight of a mixture of polypropylene powder and stannous chloride dihydrate powder (2.0 parts by weight of polypropylene powder, 0.4 parts by weight of stannous chloride dihydrate powder), followed by dynamic thermal treatment at 200±10° C., so that a thermoplastic elastomer composition was obtained. The feeding stability of stannous chloride dihydrate was good.

### Example 2

Procedures were carried out in the same manner as Example 1 except for using 2.4 parts by weight of a mixture of polyethylene powder and stannous chloride dihydrate powder (2.0 parts by weight of polyethylene powder; 0.4 parts by weight of stannous chloride dihydrate powder) instead of 2.4 parts by weight of the mixture of polypropylene powder and stannous chloride dihydrate powder. The feeding stability of stannous chloride dihydrate was excellent.

### Example 3

Procedures were carried out in the same manner as Example 1 except for using 2.4 parts by weight of a mixture of talc particle and stannous chloride dihydrate powder (2.0 parts by weight of talc particle; 0.4 parts by weight of stannous chloride dihydrate powder) instead of 2.4 parts by weight of the mixture of polypropylene powder and stannous chloride dihydrate powder. The feeding stability of stannous chloride dihydrate was good.

### Example 4

Procedures were carried out in the same manner as Example 1 except for using 2.4 parts by weight of a mixture of titanium dioxide powder and stannous chloride dihydrate powder (2.0 parts by weight of titanium dioxide powder; 0.4 parts by weight of stannous chloride dihydrate powder) instead of 2.4 parts by weight of the mixture of polypropylene powder and stannous chloride dihydrate powder. The feeding stability of stannous chloride dihydrate was excellent.

### Comparative Example 1

Procedures were carried out in the same manner as Example 1 except for using 0.4 parts by weight of stannous chloride dihydrate powder instead of 2.4 parts by weight of the mixture of polypropylene powder and stannous chloride dihydrate powder. The feeding stability of stannous chloride dihydrate was poor.

### Comparative Example 2

Procedures were carried out in the same manner as Example 1 except for using 2.4 parts by weight of a mixture of polypropylene pellets and stannous chloride dihydrate powder (2.0 parts by weight of polypropylene pellets; 0.4 parts by weight of stannous chloride dihydrate powder) instead of 2.4 parts by weight of the mixture of polypropylene powder and stannous chloride dihydrate powder. The feeding stability of stannous chloride dihydrate was poor.

1. A method for producing a thermoplastic elastomer composition, the method comprising subjecting the following component (A) and component (B) in the presence of the following component (C) and component (D) to dynamic thermal treatment within a melt-kneading apparatus, wherein the component (D) is a powder, and a mixture of a powder of the component (D) and a particle having a volume-average particle diameter of 0.1 μm to 3 mm is continuously fed to the melt-kneading apparatus,
component (A): ethylene-α-olefin-based copolymer rubber
component (B): polyolefin-based resin
component (C): alkylphenol resin
component (D): metal halide.

2. The method for producing a thermoplastic elastomer composition according to claim 1, wherein the component (A), the component (B), and the following component (E) are subjected to dynamic thermal treatment in the presence of the component (C) and the component (D) within the melt-kneading apparatus,
component (E): mineral oil.

3. The method for producing a thermoplastic elastomer composition according to claim 1, wherein the content of the component (D) in the mixture of the particle having a volume-average particle diameter of 0.1 μm to 3 mm and the powder of the component (D) is 0.1% by weight to 50% by weight.

4. The method for producing a thermoplastic elastomer composition according to claim 1, wherein the particle having a volume-average particle diameter of 0.1 μm to 3 mm is a polyolefin-based resin particle or a filler particle and the component (D) is stannous chloride.

5. The method for producing a thermoplastic elastomer composition according to claim 1, wherein the particle having a volume-average particle diameter of 0.1 μm to 3 mm has a bulk density of 0.15 to 5.0 g/cm³.

6. The method for producing a thermoplastic elastomer composition according to claim 1, wherein the melt-kneading apparatus is a twin screw extruder.

7. The method for producing a thermoplastic elastomer composition according to claim 1, wherein 10 parts by weight to 60 parts by weight of the component (A), 5 parts by weight to 50 parts by weight of the component (B), and 0 parts by weight to 70 parts by weight of the component (E) are subjected to dynamic thermal treatment in the presence of 0.5 parts by weight to 5 parts by weight of the component (C) and 0.1 parts by weight to 20 parts by weight of the component (D) where the overall amount of the component (A), the component (B), and the component (E) is 100 parts by weight.
